(19) United States
(12) Patent Application Publication
(10) Pub. No.: US 2025/0269427 A1
(43) Pub. Date: Aug. 28, 2025

(54) GOLD POWDER AND METHOD OF PRODUCING THE SAME

(71) Applicant: SUMITOMO METAL MINING CO., LTD., Tokyo (JP)

(72) Inventor: Yoshihiro Okabe, Ome-shi (JP)

(73) Assignee: SUMITOMO METAL MINING CO., LTD., Tokyo (JP)

(21) Appl. No.: 19/060,943

(22) Filed: Feb. 24, 2025

(30) Foreign Application Priority Data
Feb. 28, 2024 (JP) 2024-028531

(51) Int. Cl. B22F 1/16; B22F 1/05; B22F 1/054; B22F 9/24; C08K 9/02; C09D 5/24; C09D 7/40; C09D 7/62

(52) U.S. Cl. CPC B22F 1/16; B22F 1/05; B22F 1/054; B22F 9/24; C09D 5/24; C09D 7/62; C09D 7/68; C09D 7/69; B22F 2301/255; B22F 2304/058; B22F 2304/10; B22F 2998/10; B22F 2999/00; C08K 9/02; C08K 2201/001; C08K 2201/005

(57) ABSTRACT

Disclosed herein is a gold powder comprises gold particles, and sulfur present on a surface of at least a part of the gold particles. A sulfur amount of the sulfur present on the surface per unit surface area is 220 μg/m² or more and 1500 μg/m² or less. The sulfur amount is obtained by dividing a surface sulfur amount per unit mass by specific surface area of the gold particles. The surface sulfur amount is obtained by a quantitatively analysis of a treated liquid obtained by nitric acid extraction of the gold particles.

### TECHNICAL FIELD

The embodiments relate to a gold powder and a method of producing the same, and particularly relates to a gold powder serving as a main component of a gold paste to be used as a raw material for forming electrically-conductive films, such as wiring layers or electrodes, of electronic devices, and a method of producing the same.

### RELATED ART

Gold (Au) is chemically stable and has excellent corrosion resistance, and it also has excellent properties such as electrical conductivity and heat conductivity, and therefore it is used as an industrially useful metal in various fields. For example, in the field of electronic devices, gold is used in the form of gold paste as a raw material for producing electrically-conductive films such as wiring layers or electrodes. This gold paste is composed of components such as gold powder, resin, curing agent, and solvent and is generally prepared by kneading or mixing these components in a three-roll mill.

For example, JP 2021-111525 A discloses a technique for producing gold paste by way of weighing a gold powder as an electrically conductive metal powder, a binder resin such as epoxy resin, a curing agent such as phenol compound, and a diluent such as alkyl acetalized polyvinyl alcohol or ethylene glycol in a predetermined blending ratio, and kneading then in a three-roll mill. The gold paste produced using this method is printed in a predetermined pattern and then it is fired by heating, which can form an electrically-conductive film with the predetermined pattern. In the electrically-conductive film, gold particles constituting the gold powder connect electrically to form an electric current path, which enables the electrically-conductive film to function as a wiring layer or an electrode.

### SUMMARY

As described above, since the electrically-conductive film is formed by firing the gold paste, in order to form an electrically-conductive film with desired properties, it is preferable that a gold powder with specified properties is used as a main component of the gold paste as well as the components constituting the gold paste are blended in an appropriate ratio. The specified properties of the gold powder include powder properties that influence the properties of the electrically-conductive film, such as particle diameter, particle size distribution, specific surface area, tap density, and dispersibility. Among them, the dispersibility of gold powder in the gold paste is particularly important.

The reason why dispersibility is particularly important is that by uniformly dispersing gold powder in the gold paste, it is possible to form a wiring layer of uniform width and an electrode of uniform thickness after firing the gold paste. Conversely, if the dispersibility of gold powder in the gold paste is poor, the gold powder tends to aggregate to form aggregates, which may be crushed for example between the rolls of a three-roll mill during the kneading process of the gold paste and become flakes. Further, if aggregates or flakes larger than the thickness of an electrically-conductive film are formed, they can cause protrusions in the electrically-conductive film, leading to non-uniform film thickness or non-uniform distribution of the gold particles constituting the electrically-conductive film which may result in localized increases or decreases in the resistance value of the electrically-conductive film or may cause a mechanical problem of brittleness of the electrically-conductive film.

The dispersibility of gold powder in the gold paste can be evaluated on the basis of the following two points: whether the gold particles constituting the gold powder are dispersed individually throughout the entire paste with almost no aggregates present; and whether the surface of the gold particles is well compatible with other components of the gold paste. The tap density serves as an indicator for evaluating the former, and it is desirable that this tap density is high. On the other hand, the surface properties evaluation method represented by SP (Solubility Parameter) value can be used as an indicator for evaluating the latter. However, since the SP value is a physical property value that is defined as the square root of cohesive energy density and is intrinsic to a substance, it has different SP values for each component constituting the gold paste, which makes it difficult to generally specify its preferred range.

Further, since gold powder is a main component of the gold paste and accounts for a large proportion of the price of the gold paste, the gold powder for gold paste is required to have a low production cost. In order to reduce the production cost of gold powder, it is necessary not only to reduce the unit prices of raw materials and other materials to be used, but also to stably produce gold powder having various properties required for a gold paste at a high yield.

There is known a method for producing gold powder for the gold paste, in which an aqueous solution of a reducing agent such as a sulfurous acid salt (sodium sulfite or potassium sulfite) is added to a chloroauric acid solution containing chloroauric acid (HAuCl₄), which is obtained by, for example, subjecting waste materials such as electronic devices to leaching treatment using a solution that can dissolve gold, such as aqua regia, to reduce gold ions to precipitate gold, and the thus obtained gold powder slurry containing fine gold particles is subjected to solid-liquid separation, washing, and heat-drying.

However, gold powder produced by the above method may have variations in particle diameter and tap density, which are indicators of product quality, depending on the lot of the reducing agent used, and this may cause a quality control problem. The cause of such variations in product quality may be impurities contained in the reducing agent. For example, when potassium sulfite is used as a reducing agent, various potassium salts such as potassium sulfite hydrate, potassium bisulfite, potassium sulfate, potassium pyrosulfite, potassium thiosulfate, potassium carbonate, and potassium hydroxide may be included as impurities, which could affect the reduction reaction.

Despite these circumstances, when any of these impurities is contained in trace amounts in potassium sulfite, it is generally difficult to analyze them. Therefore, in most cases, inspecting and managing the reducing agent on a lot-by-lot basis is not effective for product quality control. In this case, it is often found after changing a lot of the reducing agent that the quality of the gold powder produced deviates from the standard. Therefore, the only current effective countermeasure to cope with this case is to regard a new lot of the reducing agent after change as defective and thus switch it to another lot of the reducing agent.

When a defective lot of the reducing agent appears as described above, it is necessary to reprocess the gold powder produced using it, and since this defective lot of the reducing agent cannot be used as it is, it must be disposed of or reprocessed, which causes a problem of increase in production cost. The embodiments have been made in light of such conventional problems, and is directed to provide gold powder with excellent dispersibility in gold paste.

A gold powder according to embodiments comprises gold particles, and sulfur present on a surface of at least a part of the gold particles. A sulfur amount of the sulfur present on the surface per unit surface area is 220 μg/m² or more and 1500 μg/m² or less. The sulfur amount is obtained by dividing a surface sulfur amount per unit mass by specific surface area of the gold particles. The surface sulfur amount is obtained by a quantitatively analysis of a treated liquid obtained by nitric acid extraction of the gold particles.

A method of producing a gold powder according to embodiments comprises a reduction step and a post-treatment step. The reduction step precipitates gold particles in a slurry by reducing a chloroauric acid solution with a reducing agent solution. The post-treatment step separates the gold particles from the slurry, washes and dries the gold particles. The reducing agent solution comprises a sulfur compound comprising divalent sulfur.

According to embodiments, a gold powder with excellent dispersibility in gold paste is provided.

### BRIEF DESCRIPTION OF DRAWINGS

FIG. 1 is a graph showing, using the average particle diameter of a gold powder as a parameter, the relationship between the sulfur amount per unit surface area and the tap density of the gold powder;

FIG. 2 is a flow diagram of a method of producing a gold powder according to an embodiment;

FIG. 3 is a graph showing the relationship between the concentration of a thiosulfuric acid salt added and the sulfur amount per unit surface area of a gold powder; and

FIG. 4 is a graph showing the relationship between the average particle diameter and the tap density of a gold powder produced by the production method according to the embodiment.

### DETAILED DESCRIPTION

Hereinbelow, embodiments of a gold powder and a method of producing the gold powder will be described in detail. It should be noted that the present invention is not limited to the following embodiments and may include various modifications and alternatives without departing from the spirit of the present invention. That is, the scope of the present invention is defined by the claims and their equivalents.

A gold powder according to embodiments comprises gold particles, and sulfur present on a surface of at least a part of the gold particles. A sulfur amount of the sulfur present on the surface per unit surface area is 220 μg/m² or more and 1500 μg/m² or less. The sulfur amount is obtained by dividing a surface sulfur amount per unit mass by specific surface area of the gold particles. The surface sulfur amount is obtained by a quantitatively analysis of a treated liquid obtained by nitric acid extraction of the gold particles.

In other words, a gold powder according to an embodiment includes gold particles having sulfur present on at least a part of its surface, and the sulfur amount of the sulfur per unit surface area of the gold powder A is 220 μg/m² or more and 1500 μg/m² or less which is determined by the following formula 1, where B is the surface sulfur amount per unit mass of the gold particles, and C is the specific surface area of the gold particles:

A=B/C [formula 1]

The surface sulfur amount per unit mass B, shown in formula 1, of the gold powder is determined by quantitatively analyzing a treated liquid obtained by nitric acid extraction treatment of the gold particles. The reason why nitric acid extraction treatment is used to determine the surface sulfur amount per unit mass of the gold powder is that it has been found that, as a result of the surface analysis of gold particles with a sulfur present on its surface by time-of-flight secondary ion mass spectrometry (TOF-SIMS), sulfur on the surface of the gold particles is present as gold sulfide to modify the gold particles. TOF-SIMS is an analysis method in which mass separation of secondary ions emitted from a surface by irradiation with a primary ion beam is performed by utilizing their difference in time-of-flight. It is preferable that the gold powder according to embodiments has the surface sulfur amount per unit mass of 50 ppm or more and 550 ppm or less.

Further, when a gold powder comprises gold particles with a sulfur adsorbed on at least a part of its surface is subjected to extraction treatment using pure water, the surface sulfur amount determined from the concentration of oxidized sulfur in a treated liquid obtained by such extraction treatment is smaller than that determined by the nitric acid extraction treatment. This is because gold is not dissolved in nitric acid, but a gold compound typified by gold sulfide is dissolved in nitric acid. Therefore, by performing qualitative and quantitative analysis on the treated liquid obtained by the nitric acid extraction treatment, it is possible to determine the surface sulfur amount, present in the form of gold sulfide, per unit mass of the gold powder. The method of the qualitative and quantitative analysis may be, for example, ICP emission spectrometry in which a solution sample having a mist form is introduced into a plasma to emit spectra specific to elements contained in the solution sample, and qualitative and quantitative analysis is performed based on the wavelengths and intensities of these spectra.

The sulfur amount per unit surface area of the gold powder according to the embodiment is 220 μg/m² or more and 1500 μg/m² or less, preferably 250 μg/m² or more and 1500 μg/m² or less, which is determined by dividing the surface sulfur amount per unit mass of the gold powder by the specific surface area of the gold particles. By setting the sulfur amount per unit surface area to fall within the range of 220 μg/m² or more and 1500 μg/m² or less, preferably 250 μg/m² or more and 1500 μg/m² or less as described above, aggregation of the gold particles in the gold powder is suppressed and dispersibility of the gold powder is enhanced, so that the tap density of the gold powder can be increased. On the other hand, if the sulfur amount per unit surface area is less than 220 μg/m², it is considered that active metallic gold portion on the surface of the gold powder increases, so that aggregation is likely to occur, which reduces the tap density of the gold powder. If the sulfur amount per unit surface area exceeds 1500 μg/m², it indicates that sulfur is excessively attached to the surface of the gold particles, which is not desirable because it may adversely affect the properties of an electrically-conductive film after firing a gold paste.

There are no particular limitations on a method of measuring the specific surface area, but the BET method is preferable and the BET one-point method that is an easier measurement method is more preferable. In the BET method, inactive molecules having a known molecular area, such as nitrogen, are adsorbed on to a cooled sample, and the specific surface area of the sample is determined from the amount of the molecules. It is known that the specific surface area of a powder varies depending on the particle diameter of the powder. Specifically, the specific surface area increases as the particle diameter decreases, and to the contrary, the specific surface area decreases as the particle diameter increases. It is preferable to use gold powder with an average particle diameter of 0.7 μm or more and 1.5 μm or less for gold paste, and more preferable to use gold powder with an average particle diameter of about 1 μm. The gold powder with an average particle diameter of larger than 1.5 μm is not preferrable because it requires a high firing temperature for forming an electrically-conductive film. On the other hand, the gold powder with an average particle diameter of less than 0.7 μm is also not preferrable because viscosity of the gold paste becomes excessively high which makes printing difficult. It is preferable that the gold powder according to embodiments has the specific surface area of 0.2 m²/g or more and 0.5 m²/g or less which is measured by the BET one-point method.

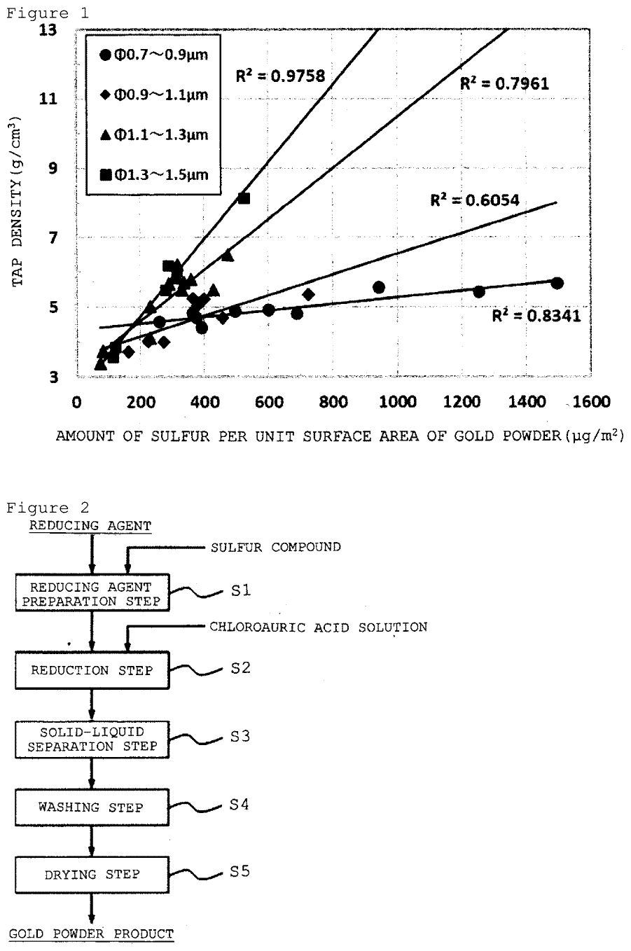

Each of various gold powders produced using different lots of reducing agents was sampled, and the sulfur amount per unit surface area (μg/m²) was determined by dividing the surface sulfur amount per unit mass by the specific surface area measured by the BET one-point method. In addition, the tap density was determined that is a bulk density of a powder sample contained in a container when the height of surface of the powder sample no longer change after the container is repeatedly dropped onto a table for tapping. The sulfur amount per unit surface area and the tap density were graphed using the particle diameters of the gold powders as parameters, and it was found that the sulfur amount per unit surface area and the tap density had a strong correlation as shown in FIG. 1.

As described above, change of the lot of the reducing agent changes the amount of a sulfur compound attached to the surface of the gold particles that is reduced by the reducing agent, which as a result influences the tap density of the gold powder. That is, when the lot of the reducing agent is switched, the surface sulfur amount per unit mass of the gold powder changes, so that the tap density also changes, which as a result affects the quality of dispersibility. Even in such a case, it is possible to estimate the tap density by using the sulfur amount per unit surface area of the gold powder as an index. Further, since the tap density is a characteristic value that depends on the average particle diameter, and the surface sulfur amount determined by quantitative analysis after nitric acid extraction treatment may change depending on the average particle diameter, it is possible to estimate the tap density of the gold powder with higher accuracy by aligning or adjusting the average particle diameter to some extent.

In order to ensure excellent dispersibility, the gold powder preferably has the tap density of 4 g/cm³ or more, more preferably 5 g/cm³ or more. Therefore, for the gold powder with an average particle diameter of 0.7 to 0.9 μm, it is preferable that the sulfur amount per unit surface area is about 700 μg/m² or more. For the gold powder with an average particle diameter of 0.9 to 1.1 μm, it is preferable that the sulfur amount per unit surface area is about 500 μg/m² or more. For the gold powder with an average particle diameter of 1.1 to 1.3 μm, it is preferable that the sulfur amount per unit surface area is about 250 μg/m² or more. For the gold powder with an average particle diameter of 1.3 to 1.5 μm, it is preferable that the sulfur amount per unit surface area is about 220 μg/m² or more.

Hereinbelow, an embodiment of a method of producing a gold powder will be described. The embodiment of producing a gold powder comprises a reduction step and a post-treatment step. The reduction step precipitates gold particles in a slurry by reducing a chloroauric acid solution with a reducing agent solution. The post-treatment step separates the gold particles from the slurry, washes and dries the gold particles. The reducing agent solution comprises a sulfur compound comprising divalent sulfur.

In other words, as shown in FIG. 2, a method of producing a gold powder according to an embodiment includes a reducing agent preparation step S1 in which a reducing agent solution having a predetermined concentration is prepared, a reduction step S2 in which a chloroauric acid solution is subjected to reduction treatment using the prepared reducing agent solution to precipitate gold particles in a slurry, a solid-liquid separation step S3 in which the slurry containing the gold particles obtained in the reduction step S2 is subjected to solid-liquid separation by solid-liquid separation means such as a filter (filter paper), a washing step S4 in which a wet gold powder obtained in the solid-liquid separation step S3 is subjected to washing treatment, and a drying step S5 in which gold particles subjected to the washing treatment is subjected to drying treatment. It should be noted that although filtration by using a filter has been described above as an example of the solid-liquid separation step S3, other solid-liquid separation means such as a filter press or a centrifuge may be used while adjustment is made in such a manner that gold particles to be separated does not deform or aggregate.

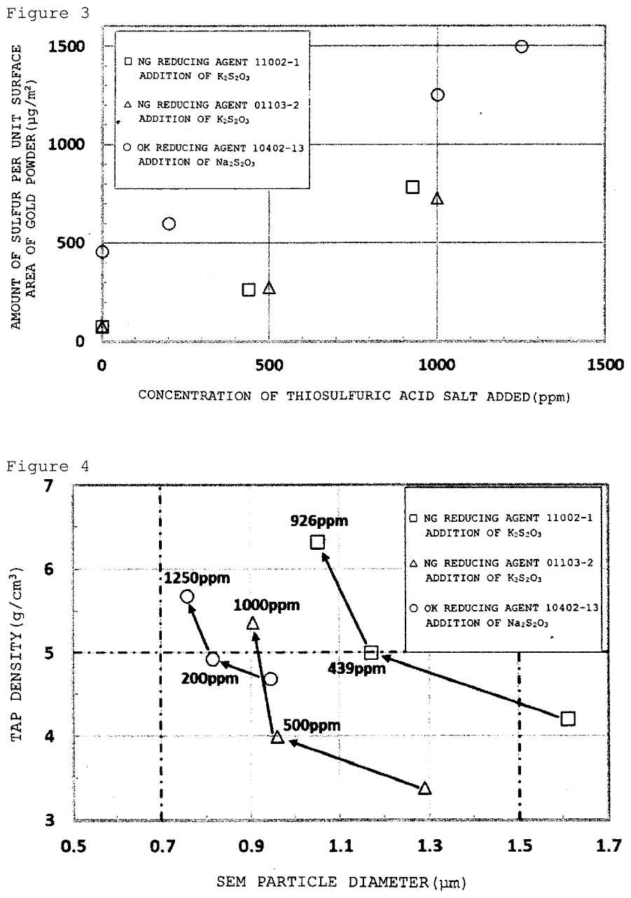

In the reducing agent preparation step S1, a compound containing divalent sulfur is added to the reducing agent solution. This makes it possible to, in the reduction step S2, reduce a chloroauric acid solution using the reducing agent solution having an increased concentration of the compound containing divalent sulfur. FIG. 3 shows the relationship between the concentration of the compound containing divalent sulfur added to the reducing agent solution and the sulfur amount per unit surface area of the gold powder obtained by reduction using the reducing agent solution. From FIG. 3, it can be seen that the sulfur amount per unit surface area of the gold powder increases almost linearly with the increase in the concentration of the compound containing divalent sulfur added to the reducing agent solution for each lot of a reducing agent. That is, the sulfur amount per unit surface area of the gold powder can be controlled by the amount of the compound containing divalent sulfur to be added to the reducing agent solution.

As described above, the use of the method of producing a gold powder according to the embodiment makes it possible to stably produce a gold powder with a high tap density and excellent dispersibility. Further, since the tap density can be indirectly controlled by the amount of a thiosulfuric acid salt to be added to the reducing agent, it is possible to appropriately adjust the concentration of a thiosulfuric acid salt to be added for each lot of the reducing agent, thereby avoiding waste of the reducing agent or incurring an extra reprocessing cost, which can reduce a production cost.

Potassium sulfite or sodium sulfite can used as a reducing agent for reducing the chloroauric acid solution. Potassium thiosulfate or sodium thiosulfate can be used as a compound containing divalent sulfur to be added to the reducing agent solution. The combination of the sulfurous acid salt as a reducing agent and the thiosulfuric acid salt to be added may freely be selected. Hereinbelow, the gold powder and the production method thereof will be described in more detail with reference to examples and comparative examples, but the present invention is not limited by the following examples and comparative examples.

### EXAMPLES

### Example 1

A chloroauric acid solution of 2.4 L diluted with pure water to have a gold concentration of 33.3 g/L was charged into a 5-liter beaker equipped with a stirrer having a flat paddle impeller with a diameter of 60 mm and was adjusted to a liquid temperature of 18±1° C. On the other hand, potassium sulfite (manufactured by Daito Kagaku K.K.: Lot No. 11002-1) was dissolved in pure water to prepare a reducing agent solution with a concentration of 450 g/L and a liquid volume of 480 mL, and the reducing agent solution was charged into a 2-liter beaker and was adjusted to a liquid temperature of 18±1° C. To this reducing agent solution, 0.11 g of potassium thiosulfate n-hydrate (Cica special grade manufactured by KANTO CHEMICAL CO., INC.: 87% as anhydride) was added and dissolved to achieve its concentration of 439 ppm relative to the amount of potassium sulfite.

Four baffles each having a strip-shape with 15 mm width were provided on the inner wall of the 5-liter beaker containing the chloroauric acid solution at equal intervals (i.e., every 90 degrees) in its circumferential direction, and reduction treatment was performed by supplying the reducing agent solution thereto while maintaining a turbulent state by rotating the stirrer at 530 rpm. The reducing agent solution was supplied through a funnel whose lower outlet was fixed to any position on the circumference of a circle with a radius of about one-half of the radius of the 5-liter beaker containing the chloroauric acid solution when viewed from above. This funnel had a capacity of about 1 liter, and a valve and a hose with an inner diameter of 21 mm were attached to the lower outlet. This arrangement allows the temperature-adjusted reducing agent solution to be temporarily stored in the funnel, and then supplied to a fixed position for a fixed period of time by always fully opening the valve at once. As a result, the supply time for 480 mL of the reducing agent solution was 1.6 seconds.

After the reducing agent solution was supplied in such a manner as described above, stirring was continued for 5 minutes. During this time, as the liquid temperature increased by several degrees and the pH decreased due to the reduction reaction, but the increase in liquid temperature stopped after a lapse of about 1 minute, and the decrease in pH stopped after a lapse of about 5 minutes. After a lapse of 5 minutes from the supply of the reducing agent solution, a slurry containing gold particles was filtered through filter paper for solid-liquid separation to collect the gold particles. The collected gold powder was charged into 1 liter of pure water at about 50° C. for repulping and was washed by stirring for 20 minutes. The slurry containing a washed gold powder was again filtered through filter paper for solid-liquid separation to collect the gold particles. The collected gold powder was charged into 1 liter of pure water at room temperature for repulping and was rewashed by stirring for 20 minutes. The slurry containing a rewashed gold powder was filtered through filter paper for solid-liquid separation for the third time to collect the gold particles. The collected gold powder was subjected to heat-drying treatment in an atmospheric oven at an ambient temperature of 105° C. The gold particles after drying treatment was weighed and found to be about 79 g.

The obtained gold particles, i.e. gold powder, after drying treatment was imaged by using a scanning electron microscope (SEM), and the particle diameter of the gold powder was measured on the SEM photograph at a magnification of 5000 times. The particle diameters were measured for 200 or more gold particles randomly selected in 1 to 3 field of views, and then an average particle diameter was obtained by calculating the arithmetic average of these measurements. Further, the specific surface area of the gold powder was measured by the BET one-point method, and the surface sulfur amount per unit mass of the gold powder was calculated by subjecting a treated liquid obtained by nitric acid extraction treatment to ICP emission spectrometric analysis. Furthermore, the tap density of the gold powder was measured by tapping 10 to 12 cm³ of a sample with a stoke height of 10 mm for 50 times.

The obtained gold powder had an average particle diameter of 1.17 μm, a tap density of 5.00 g/cm³, and a specific surface area of 0.22 m²/g, the surface sulfur amount per unit mass of the gold powder was 57 ppm, and the sulfur amount per unit surface area of the gold powder was 265 μg/m².

### Example 2

A gold powder was produced in the same manner as in Example 1 except that 0.23 g of potassium thiosulfate n-hydrate was added to achieve its concentration of 926 ppm relative to the amount of potassium sulfite.

The obtained gold powder had an average particle diameter of 1.05 μm, a tap density of 6.32 g/cm³, and a specific surface area of 0.26 m²/g, the surface sulfur amount per unit mass of the gold powder was 200 ppm, and the sulfur amount per unit surface area of the gold powder was 784 μg/m².

### Example 3

A gold powder was produced in the same manner as in Example 1 except that the reducing agent solution was changed to a reducing agent solution with a liquid volume of 0.80 L prepared by dissolving potassium sulfite (Lot. No. 01103-2) in pure water to have a concentration of 250 g/L, and that 0.23 g of potassium thiosulfate n-hydrate was added to and dissolved in the reducing agent solution to achieve its concentration of 1000 ppm relative to the amount of potassium sulfite.

The obtained gold powder had an average particle diameter of 0.90 μm, a tap density of 5.36 g/cm³, and a specific surface area of 0.29 m²/g, the surface sulfur amount per unit mass of the gold powder was 210 ppm, and the sulfur amount per unit surface area of the gold powder was 724 μg/m².

### Example 4

A gold powder was produced in the same manner as in Example 3 except that 0.12 g of potassium thiosulfate n-hydrate was added to achieve its concentration of 500 ppm relative to the amount of potassium sulfite.

The obtained gold powder had an average particle diameter of 0.96 μm, a tap density of 4.00 g/cm³, and a specific surface area of 0.26 m²/g, the surface sulfur amount per unit mass of the gold powder was 72 ppm, and the sulfur amount per unit surface area of the gold powder was 273 μg/m².

### Example 5

A gold powder was produced in the same manner as in Example 3 except that another lot (Lot. No. 10402-13) of the reducing agent was used and that potassium thiosulfate n-hydrate was not added.

The obtained gold powder had an average particle diameter of 0.95 μm, a tap density of 4.69 g/cm³, and a specific surface area of 0.28 m²/g, the surface sulfur amount per unit mass of the gold powder was 130 ppm, and the sulfur amount per unit surface area of the gold powder was 458 μg/m².

### Example 6

A gold powder was produced in the same manner as in Example 5 except that sodium thiosulfate pentahydrate (manufactured by KANTO CHEMICAL CO., INC., 99%) was added as additive and that 0.06 g of sodium thiosulfate pentahydrate was added to achieve its concentration of 200 ppm relative to the amount of potassium sulfite.

The obtained gold powder had an average particle diameter of 0.82 μm, a tap density of 4.93 g/cm³, and a specific surface area of 0.28 m²/g, the surface sulfur amount per unit mass of the gold powder was 170 ppm, and the sulfur amount per unit surface area of the gold powder was 599 μg/m².

### Example 7

A gold powder was produced in the same manner as in Example 6 except that 0.39 g of sodium thiosulfate pentahydrate was added to achieve its concentration of 1250 ppm relative to the amount of potassium sulfite.

The obtained gold powder had an average particle diameter of 0.76 μm, a tap density of 5.68 g/cm³, and a specific surface area of 0.37 m²/g, the surface sulfur amount per unit mass of the gold powder was 550 ppm, and the sulfur amount per unit surface area of the gold powder was 1495 μg/m².

### Comparative Example 1

A gold powder was produced in the same manner as in Example 1 except that potassium thiosulfate n-hydrate was not added.

The obtained gold powder had an average particle diameter of 1.61 μm, a tap density of 4.21 g/cm³, and a specific surface area of 0.17 m²/g, the surface sulfur amount per unit mass of the gold powder was 13 ppm, and the sulfur amount per unit surface area of the gold powder was 76 μg/m².

### Comparative Example 2

A gold powder was produced in the same manner as in Example 3 except that potassium thiosulfate n-hydrate was not added.

The obtained gold powder had an average particle diameter of 1.29 μm, a tap density of 3.38 g/cm³, and a specific surface area of 0.20 m²/g, the surface sulfur amount per unit mass of the gold powder was 15 ppm, and the sulfur amount per unit surface area of the gold powder was 75 μg/m².

### Evaluation

The conditions used in Examples and Comparative Examples and the evaluation results of the produced gold powders are shown below in Table 1. As can be seen from the results shown in Table 1, the produced gold powders are different in their properties from each other even when reduction is performed under the same conditions except for the amount of the thiosulfuric acid salt added. This confirms that when the lot of a reducing agent is changed, the properties of a gold powder can be changed by appropriately adjusting the amount of a thiosulfuric acid salt to be added, and as a result, the sulfur amount per unit surface area of the gold powder can be increased as necessary, which allows increasing the tap density of the gold powder to a suitable level for use in gold paste.

TABLE 1

| | Conditions | | | | | | |
|---|---|---|---|---|---|---|---|
| | Au solution | | Reducing agent solution | | | | |
| | Au | Liquid | Reducing agent | | Liquid | Additive | |
| | concentration | volume | | Concentration | volume | | Concentration |
| | [g/L] | [mL] | Lot. No. | [g/L] | [mL] | Type | [ppm] |
| Comparative | 33.3 | 2400 | 11002-1 | 450 | 480 | — | — |
| Example 1 | | | | | | | |
| Example 1 | 33.3 | 2400 | 11002-1 | 450 | 480 | K₂S₂O₃ | 379 |
| Example 2 | 33.3 | 2400 | 11002-1 | 450 | 480 | K₂S₂O₃ | 926 |
| Comparative | 33.3 | 2400 | 01103-2 | 250 | 800 | — | — |
| Example 2 | | | | | | | |
| Example 3 | 33.3 | 2400 | 01103-2 | 250 | 800 | K₂S₂O₃ | 500 |
| Example 4 | 33.3 | 2400 | 01103-2 | 250 | 800 | K₂S₂O₃ | 1000 |
| Example 5 | 33.3 | 2400 | 10402-13 | 250 | 800 | — | — |
| Example 6 | 33.3 | 2400 | 10402-13 | 250 | 800 | Na₂S₂O₃ | 200 |
| Example 7 | 33.3 | 2400 | 10402-13 | 250 | 800 | Na₂S₂O₃ | 1250 |

| | Conditions | Evaluation results | | | | |
|---|---|---|---|---|---|---|
| | Reducing | | | | Surface | Sulfur |
| | agent | | | | sulfur | amount |
| | solution | SEM | | | amount | per unit |
| | Charging | average | | Specific | per unit | surface |
| | time | particle | Tap | surface | mass | area |
| | period | diameter | density | area | of Au | of Au |
| | [s] | [μm] | [g/cm³] | [m²/g] | [ppm] | [μg/m²] |
| Comparative | 1.6 | 1.61 | 4.21 | 0.17 | 13 | 76 |
| Example 1 | | | | | | |
| Example 1 | 1.6 | 1.17 | 5.00 | 0.22 | 57 | 265 |
| Example 2 | 1.6 | 1.05 | 6.32 | 0.26 | 200 | 784 |
| Comparative | 2.8 | 1.29 | 3.38 | 0.20 | 15 | 75 |
| Example 2 | | | | | | |
| Example 3 | 2.8 | 0.96 | 4.00 | 0.26 | 72 | 273 |
| Example 4 | 2.8 | 0.90 | 5.36 | 0.29 | 210 | 724 |
| Example 5 | 2.8 | 0.95 | 4.69 | 0.28 | 130 | 458 |
| Example 6 | 2.8 | 0.82 | 4.93 | 0.28 | 170 | 599 |
| Example 7 | 2.8 | 0.76 | 5.68 | 0.37 | 550 | 1495 |

FIG. 4 is a graph showing changes in the average particle diameters and the tap densities of the gold powders produced in Comparative Examples and Examples with the amounts of the thiosulfuric acid salt added as parameters. As general powder characteristics, the tap density increases as the average particle diameter increases, but FIG. 4 indicates that when the thiosulfuric acid salt is added, the tap density increases as the average particle diameter decreases. This confirms that even when the lot of a reducing agent is changed, a gold powder suitable for use in gold paste can stably be produced by adjusting the amount of a thiosulfuric acid salt to be added, although there is a case where in the reduction step, reduction conditions are appropriately adjusted after adding the thiosulfuric acid salt in such a manner that the average particle diameter of the gold powder falls within the range of 0.7 μm to 1.5 μm. That is, according to each of the embodiments, it is possible to stably produce a gold powder excellent in dispersibility in gold paste with high yield.

What is claimed is:

1. A gold powder, comprising:
gold particles; and
sulfur present on a surface of at least a part of the gold particles, wherein
a sulfur amount of the sulfur present on the surface per unit surface area is 220 μg/m² or more and 1500 μg/m² or less, and
the sulfur amount is obtained by dividing a surface sulfur amount per unit mass by specific surface area of the gold particles, the surface sulfur amount is obtained by a quantitatively analysis of a treated liquid obtained by nitric acid extraction of the gold particles.

2. The gold powder according to claim 1, wherein an average particle diameter measured on SEM image is 0.7 μm or more and 1.5 μm or less.

3. A method of producing a gold powder, comprising:
precipitating gold particles in a slurry by reducing a chloroauric acid solution with a reducing agent solution; and
separating, washing and drying the gold particles from the slurry, wherein,
the reducing agent solution comprises a sulfur compound comprising divalent sulfur.

4. The method of producing a gold powder according to claim 3, wherein
the reducing agent solution comprises potassium sulfite or sodium sulfite as a reducing agent, and
the sulfur compound comprises potassium thiosulfate or sodium thiosulfate.
